(19) United States
(12) Patent Application Publication
(10) Pub. No.: US 2024/0079639 A1
(43) Pub. Date: Mar. 7, 2024

(54) SOLVENT FOR PREPARING SOLID ELECTROLYTE LAYER, BINDER COMPOSITION COMPRISING SAME, AND SOLID ELECTROLYTE LAYER, ELECTRODE, AND ALL-SOLID BATTERY FORMED BY USING SAME

(71) Applicant: Samsung SDI Co., Ltd., Yongin-si (KR)

(72) Inventors: Seungsik Hwang, Suwon-si (KR); Mokwon Kim, Suwon-si (KR)

(21) Appl. No.: 18/162,930

(22) Filed: Feb. 1, 2023

(30) Foreign Application Priority Data
Aug. 24, 2022 (KR) 10-2022-0106060

(51) Int. Cl. H01M 10/0562; H01M 4/62

(52) U.S. Cl. CPC H01M 10/0562; H01M 4/622; H01M 2300/008

(57) ABSTRACT

A solvent for preparing a solid electrolyte layer, wherein the solvent has a vapor pressure of about 26.66 Pascal to about 600 Pascal at 25° C., and wherein the solvent satisfies Equation 1:

δ²=(δD)²+(δP)²+(δH)² Equation 1

wherein δ is a Hansen solubility parameter, and δ is about 16.4 MPa^{1/2} to about 18.2 MPa^{1/2}, δD is a dispersion energy parameter, and δD is about 15 MPa^{1/2} to about 18.2 MPa^{1/2}, δP is a polar-dipolar energy parameter, and δP is about 0 MPa^{1/2} to about 4 MPa^{1/2}, and δH is a hydrogen bonding energy parameter, and δH is about 0 MPa^{1/2} to about 6 MPa^{1/2}.

### CROSS-REFERENCE TO RELATED APPLICATION

This application claims priority to and the benefit of Korean Patent Application No. 10-2022-0106060, filed on Aug. 24, 2022, in the Korean Intellectual Property Office, and all the benefits accruing therefrom under 35 U.S.C. § 119, the entire content of which is incorporated by reference herein.

### BACKGROUND

### 1. Field

The disclosure relates to a solvent for preparing a solid electrolyte layer, a binder composition including the solvent, a solid electrolyte layer, an electrode, and an all-solid battery formed by using the solvent.

### 2. Description of the Related Art

There is a growing market for energy storage devices that have the capability to store and use a large amount of electric energy, which is useful for electric vehicles. In line with this trend, there is a growing demand for improved safety as well as higher capacity for lithium batteries. Lithium batteries using liquid electrolytes may have a greater risk of explosion due to ignition of the solvents used for the electrolyte, and therefore the use solid electrolytes instead of liquid electrolytes could reduce the risk of explosion.

Among such solid electrolytes, sulfide-containing solid electrolytes are solid electrolytes with a high energy density and a high ductility. In addition, sulfide-containing solid electrolytes have ionic conductivity that is as good as liquid electrolytes. However, sulfide-containing solid electrolytes are more reactive during film formation, and when exposed to the atmosphere, may react with moisture to generate hydrogen sulfide gas, which is harmful to the human body. Hydrogen sulfide also causes a decrease in ionic conductivity by causing a rapid increase in the internal pressure of a battery cell or delamination of active material.

In this context, there is a continuing demand for a solvent useful for preparing a solid electrolyte layer that can maintain viscosity stability of the slurry during film formation while having lower reactivity with a sulfide-containing solid electrolyte.

### SUMMARY

Provided is a solvent for preparing a solid electrolyte layer, which, due to its lower reactivity with a solid electrolyte, allows the viscosity of the slurry to remain stable during film formation and provides excellent film forming characteristics while maintaining higher ionic conductivity.

Provided is a binder composition including the solvent.

Provided is a solid electrolyte layer formed using the solvent.

Provided is an electrode formed using the solvent.

Provided is an all-solid battery formed using the solvent.

Additional aspects will be set forth in part in the detailed description that follows and, in part, will be apparent from the description, or may be learned by practice of the presented exemplary embodiments described herein.

According to an aspect, a solvent for preparing a solid electrolyte layer is provided, wherein the solvent has a vapor pressure of about 26.66 Pascal to about 600 Pascal at 25° C., and
wherein the solvent satisfies Equation 1:

δ²=(δD)²+(δP)²+(δH)² Equation 1
δ is a Hansen solubility parameter, and δ is about 16.4 MPa^{1/2} to about 18.2 MPa^{1/2}
δD is a dispersion energy parameter, and δD is about 15 MPa^{1/2} to about 18.2 MPa^{1/2}
δP is a polar-dipolar energy parameter, and δP is about 0 MPa^{1/2} to about 4 MPa^{1/2} and
   δH is a hydrogen bonding energy parameter, and δH is about 0 MPa^{1/2} to about 6 MPa^{1/2}.

According to another aspect, a binder composition includes the above-described solvent and a binder.

According to another aspect, a solid electrolyte layer is formed using a solid electrolyte slurry including a sulfide-containing solid electrolyte, the above-described solvent, and a binder.

According to another aspect, an electrode formed using an electrode active material slurry includes an electrode current collector, and an electrode active material layer disposed on the electrode current collector, wherein the electrode active material layer includes an electrode active material, a sulfide-containing solid electrolyte, the above-described solvent, a conductive material, and a binder.

According to another aspect, an all-solid battery includes a cathode including the above-described electrode, an anode, and a solid electrolyte layer disposed between the cathode and the anode.

According to another aspect, an all-solid battery includes a cathode, an anode, and the above-described solid electrolyte layer disposed between the cathode and the anode.

### BRIEF DESCRIPTION OF THE DRAWINGS

The above and other aspects, features, and advantages of certain exemplary embodiments will be more apparent from the following detailed description taken in conjunction with the accompanying drawings, in which:

FIG. 1 is a cross-sectional view of an all-solid battery according to one or more embodiments.

FIG. 2 is a cross-sectional view of an all-solid battery according to one or more embodiments.

### DETAILED DESCRIPTION

Reference will now be made in further detail to exemplary embodiments, examples of which are illustrated in the accompanying drawings, wherein like reference numerals refer to like elements throughout. In this regard, the present exemplary embodiments may have different forms and should not be construed as being limited to the detailed descriptions set forth herein. Accordingly, the exemplary embodiments are merely described in further detail below, by referring to the figures, to explain certain aspects. As used herein, the term “and/or” includes any and all combinations of one or more of the associated listed items. Expressions such as “at least one of,” when preceding a list of elements, modify the entire list of elements and do not modify the individual elements of the list.

The disclosure, which will be more fully described hereinafter, may have various variations and various embodiments, and specific embodiments will be illustrated in the accompanied drawings and described in greater detail. However, the present subject matter should not be construed as being limited to the specific embodiments set forth herein. Rather, these embodiments are to be understood as encompassing all variations, equivalents, or alternatives included in the scope of the present disclosure.

The terminology used hereinbelow is used for the purpose of describing particular embodiments only and is not intended to limit the present disclosure. As used herein, the singular forms are intended to include the plural forms as well, unless the context clearly indicates otherwise.

Expressions such as “at least one” and “one or more” as used herein, when preceding a list of elements, may modify the entire list of elements and do not modify the individual elements of the list. As used herein, the term “combination” includes mixtures, alloys, reaction products, or the like, unless otherwise specified. The terms “comprise(s)” and/or “comprising,” or “include(s)” and/or “including” as used herein, unless otherwise specified, do not preclude the presence or addition of one or more other elements. As used herein, the terms “first”, “second”, or the like do not indicate sequence, amount, or significance, but are used to distinguish one element from another element. As used herein, the singular forms are intended to include the plural forms as well, unless otherwise specified or the context clearly indicates otherwise. As used herein, the term “or” means “and/or” unless otherwise stated.

As used herein, in “one or more embodiments”, “an embodiment”, “embodiment”, or the like, a specific feature disclosed therein may be included in at least one example disclosed herein, and may or may not be present in another embodiment. Further, it should be understood that the elements disclosed herein may be combined by any appropriate means in various embodiments.

Unless otherwise stated, all percentages, parts, ratios, or the like, are based on weight. Also, when an amount, concentration, or other value or parameter is given as any one of a range, a preferable range, or a list of a preferable upper limit and a preferable lower limit, this should be interpreted as disclosing all specific ranges formed by any pair of any upper range limit or a preferable value and any lower range limit or a preferable value, regardless of whether such a range is separately stated.

Unless defined otherwise, a range of numerical values, as used herein, includes all integers and fractions within that range including end points. Where a range of values is provided herein, the range is not intended to be limited by specific values that are mentioned when defining the range.

In the specification, unless specifically defined otherwise, a unit “parts by weight” refers to a weight ratio between components, and a unit “parts by mass” refers to a value obtained by converting a weight ratio between components in terms of solids content.

As used herein, the term “about” is used to include a stated value and refers to within an allowable range of deviation with respect to a specific value determined by a person of ordinary skill in the art in consideration of errors associated with a corresponding measurement and the measurement of a specific amount (that is, limitations of a measurement system). For example, the expression “about” shall mean within one or more standard deviations, or within ±30%, 20%, 10%, or 5% of an indicated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized sense. Further, the terms used herein should not be interpreted in an overly formal sense.

Exemplary embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes illustrated herein, and instead include deviations in shapes that result, for example, from manufacturing. For example, a region illustrated or described as flat may, for example, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

Hereinbelow, a solvent for preparing a solid electrolyte layer, a binder composition including the same, a solid electrolyte layer, an electrode, and an all-solid battery formed by using the solvent will be described in further detail with reference to exemplary embodiments.

When forming a sulfide-containing solid electrolyte layer, a non-polar solvent may be used. Examples of the non-polar solvent may include xylene, toluene, hexane, heptane, 1,2-dichlorobenzene, or the like. The non-polar solvent may have a high volatility due to its low boiling point and high vapor pressure, and thus may cause viscosity stability of the slurry to decrease during formation of solid electrolyte layers. The non-polar solvent due to its high volatility may cause non-uniformity of viscosity during preparation of a solid electrolyte slurry, and drying may occur at the nozzle head of a solid electrolyte slurry coater during mass-production. For example, alkyl oleate-containing solvents have an extremely low vapor pressure of about 0.00003 Pa (3×10⁻⁵ mmHg) or less, and therefore requires a large amount of energy for solvent removal during drying and may cause the process cost to increase. Polar solvents such as n-methyl pyrrolidinone (NMP) have greater reactivity with sulfide-containing solid electrolyte.

A solvent for preparing a solid electrolyte layer according to an aspect has a vapor pressure of about 26.66 Pascal (0.2 mmHg) to about 600 Pascal (4.5 mmHg) at 25° C., wherein the solvent satisfies Equation 1:

δ²=(δD)²+(δP)²+(δH)² Equation 1
wherein, in Equation 1, δ is a Hansen solubility parameter, and δ is about 16.4 MPa^{1/2} to about 18.2 MPa^{1/2}; δD is a dispersion energy parameter, and δD is about 15 MPa^{1/2} to about 18.2 MPa^{1/2}; δP is a polar-dipolar energy parameter, and δP is about 0 MPa^{1/2} to about 4 MPa^{1/2}; and δH is a hydrogen bonding energy parameter, and δH is about 0 MPa^{1/2} to about 6 MPa^{1/2}.

The solvent for preparing a solid electrolyte layer, when having a vapor pressure within the above range at 25° C., may have low volatility and maintain the viscosity stability of the solid electrolyte slurry. The vapor pressure may be measured by a known measurement method such as a gas-saturation method, a static test method using an isoteniscope, a dynamic test method using a boiling point, or the like.

Meanwhile, to determine solubility or miscibility between materials, similarities of the materials need to be compared using inherent properties of the materials. Among such inherent properties that affect solubility or miscibility, solubility parameters, which express the degree of interaction between materials as quantitative values, are commonly used. Materials with similar solubility parameters may be readily dissolved in or mixed with each other. Among such solubility parameters, Hansen solubility parameters (HSP) proposed by Dr. C. Hansen in 1967 provide the most accurate representation of solubility characteristics.

Hansen solubility parameters (HSP, δ) may represent the degree of bonding between materials by an equation represented by Equation 1 below. In this equation, δD represents a dispersion energy parameter generated from non-polar dispersion bonding, δP represents a polar-dipolar energy parameter generated from polar bonding due to dipoles, and δH represents a hydrogen bonding energy parameter generated from hydrogen bonds. Such HSP values are calculated by using a program called Hansen Solubility Parameters in Practice (HSPiP) developed by the Hansen Group, which proposed HSP.

In the Hansen solubility parameter equation represented by Equation 1 for the solvent for preparing a solid electrolyte layer, δ is about 16.4 MPa^{1/2} to about 18.2 MPa^{1/2} δD is about 15 MPa^{1/2} to about 18.2 MPa^{1/2}, δP is about 0 MPa^{1/2} to about 4 MPa^{1/2}, and δH is about 0 MPa^{1/2} to about 6 MPa^{1/2}. The solvent for preparing a solid electrolyte layer may permit dissolution of binder polymers while having lower reactivity with a solid electrolyte, in particular, a sulfide-containing solid electrolyte, and thus allow the viscosity of the slurry to remain stable during film formation and provide excellent film forming characteristics and maintain high ionic conductivity.

The solvent may further satisfy Equation 2 below:

Ra²=4(δD₁−δD₂)²+(δP₁-δP₂)²+(δH₁−δH₂)² Equation 2

wherein, in Equation 2,
Ra is a Hansen solubility parameter distance (expressed in MPa^{1/2}),
δD₁ is a dispersion energy parameter (expressed in MPa^{1/2}) for 2-ethylhexyl acetate or xylene,
δD₂ is a dispersion energy parameter (expressed in MPa^{1/2}) for the solvent (other than 2-ethylhexyl acetate or xylene),
δP₁ is a polar-dipolar energy parameter (expressed in MPa^{1/2}) for 2-ethylhexyl acetate or xylene,
δP₂ is a polar-dipolar energy parameter (expressed in MPa^{1/2}) for the solvent (other than 2-ethylhexyl acetate or xylene),
δH₁ is a hydrogen bonding energy parameter (expressed in MPa^{1/2}) for 2-ethylhexyl acetate or xylene, and
δH₂ is a hydrogen bonding energy parameter (expressed in MPa^{1/2}) for the solvent (other than 2-ethylhexyl acetate or xylene).

The Hansen solubility parameter distance (Ra) for 2-ethylhexyl acetate calculated by Equation 2 may be about 0 MPa^{1/2} to about 3 MPa^{1/2}, and/or a Hansen solubility parameter distance (Ra) for xylene calculated by Equation 2 may be about 0 MPa^{1/2} to about 5 MPa^{1/2}.

The Hansen solubility parameters may be expressed as coordinates in a three-dimensional space. The Hansen solubility parameters may satisfy Equation 2 of Hansen solubility parameter distance (Ra). The Hansen solubility parameter distance may be used such that, when solubility (compatibility) between solvent A and solvent B is to be determined, if the coordinates for solvent A in three dimensions and the coordinates for solvent B in three dimensions are close to each other in the space, the two solvents are considered to have high solubility (compatibility). On the other hand, if the coordinates for solvent A in three dimensions and the coordinates for solvent B in three dimensions are far from each other in the space, the two solvents are considered to have low solubility (compatibility). That is, it is considered such that the lower the Hansen solubility parameter distance (Ra) value in Equation 2, the higher the solubility (compatibility) between solvent A and solvent B, and the greater the Hansen solubility parameter distance (Ra) value in Equation 2, the lower the solubility (compatibility) between solvent A and solvent B.

When the Hansen solubility parameter distance (Ra) for 2-ethylhexyl acetate and/or the Hansen solubility parameter distance (Ra) for xylene, calculated by Equation 2, is within the above ranges, the solvent for preparing a solid electrolyte layer may permit dissolution of binder polymers while having lower reactivity with a solid electrolyte, in particular, a sulfide-containing solid electrolyte, and thus allow the viscosity of the slurry to remain stable during film formation and provide excellent film forming characteristics while maintaining high ionic conductivity.

The solvent may have a boiling point of about 145° C. and to about 220° C. For example, the solvent may have a boiling point of about 160° C. to about 220° C., about 170° C. to about 210° C., or about 190° C. to about 210° C. For the boiling point of the solvent, values disclosed in the information disclosed in Material Safety Data Sheet (MSDS) and information disclosed in the literature were used. When the boiling point of the solvent are within the above ranges, the solvents may have lower volatility and have greater stability when forming a solid electrolyte layer.

The solvent may have a flash point of about 30° C. to about 90° C. For example, the solvent may have a flash point of about 30° C. to about 85° C., about 30° C. to about 80° C., about 30° C. to about 75° C., or about 31° C. to about 71° C. For the flash point of the solvent, information provided by the manufacturer and supplier and the information disclosed in MSDS were used. When the flash point of the solvent is within the above ranges, greater stability can be achieved when forming a solid electrolyte layer.

The solvent may include one or more of isobutyl isobutyrate, n-butyl butyrate, 2-ethylhexyl acetate, ethyl hexanoate, diisobutyl ketone, n-heptyl acetate, hexyl acetate, d-limonene, trimethylbenzene, or isopropylbenzene. For example, the solvent may include one or more of 2-ethylhexyl acetate, hexyl acetate, or isopropylbenzene.

A binder composition according to another embodiment may include the above-described solvent and a binder. Once the binder is dissolved in the solvent, the binder composition may have lower reactivity with the solid electrolyte, in particular with sulfide-containing solid electrolytes. As such, the binder composition may be appropriate for use in the preparation of a solid electrolyte slurry.

The binder may include a hydrocarbon-based rubber. For example, the binder may include a butadiene rubber, a butyl rubber, an acrylic rubber, an acrylate resin, a silicone resin, a fluorine-containing elastomer, or a urethane-containing elastomer. The butadiene rubber may or may not include a polar group within the molecules. For example, the butadiene rubber may include a polar group. Examples of the polar group may include a nitrile group, an acrylate group, an acrylonitrile group, or the like. Inclusion of such polar groups within molecules may provide excellent dispersibility due to high oil resistance, and thus may be advantageous in dispersing a solid electrolyte, an electrode active material, and a conductive material. The butyl rubber may be isobutylene isoprene rubber, and the acrylic rubber may be acrylic rubber.

The binder may include one or more of a polybutadiene rubber, a nitrile-butadiene rubber, a hydrogenated nitrile-butadiene rubber, a styrene-butadiene rubber, styrene-a butadiene-styrene rubber, an acrylate-butadiene rubber, a methacrylate-butadiene rubber, an acrylonitrile-butadiene-styrene rubber, a polyacrylate rubber, polyisobutene, a polyolefin elastomer, ethylene-propylene-diene terpolymer (EPDM) rubber, isobutylene-isoprene rubber, poly(ethylene-co-vinyl acetate), a chloroprene rubber, a chlorosulfonated polyethylene, poly(vinylidene fluoride-co-hexafluoropropylene) (PVDF-HFP), or a polyurethane.

The binder composition may have a solids concentration of about 0.1 weight percent (wt %) to about 20 wt %, based on the total weight of the binder composition. For example, the binder composition may have a solids concentration of about 0.1 wt % to about 5 wt %, based on the total weight of the binder composition. If the solids concentration of the binder composition is less than 0.1 wt %, densification of the solid electrolyte layer may deteriorate. If the solids concentration of the binder composition exceeds 20 wt %, it may be difficult to conduct a uniform and stable slurry preparation due to increased viscosity of the binder solution.

A solid electrolyte layer according to one or more embodiments may be formed using a solid electrolyte slurry including a sulfide-containing solid electrolyte; the above-described solvent; and a binder. The sulfide-containing solid electrolyte is not limited to any particular material and may be any material that contains sulfur (S) or an element that belongs to the same group as sulfur (Se, Te) and has ionic conductivity. For example, the sulfide-containing solid electrolyte may include Li₂S—P₂S₅; Li₂S—P₂S₅—LiX wherein X is a halogen element; Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCL; Li₂S—SiS₂—B₂S₃—LiI; Li₂S—SiS₂—P₂S₅—LiI; Li₂S—B₂S₃; Li₂S—P₂S₅—ZₘSₙ wherein m and n are each a positive number, Z is Ge, Zn, Ga, or a combination thereof; Li₂S—GeS₂; Li₂S—SiS₂—Li₃PO₄; Li₂S—SiS₂-LiₚMO_{q} wherein p and q are each a positive number, and M is P, Si, Ge, B, Al, Ga, In, or a combination thereof; or a combination thereof. If a material containing Li₂S—P₂S₅ is used as the sulfide-containing solid electrolyte material, a mixing molar ratio of Li₂S and P₂S₅ may be about 50:50 to about 90:10, or about 60:40 to about 90:10, or about 75:25 to about 90:10.

For example, the sulfide-containing solid electrolyte may include a solid electrolyte represented by Formula 1:

Li⁺_{12-n-z}Aⁿ⁺B²⁻_{6-z}Y′⁻_{z}. Formula 1

In Formula 1,
A may be P, As, Ge, Ga, Sb, Si, Sn, Al, In, Tl, V, Nb, or Ta,
B may be S, Se, or Te,
Y′ may be Cl, Br, I, F, CN, OCN, SCN, or N₃,
1<n<5, and
0<z<2.

The sulfide-containing solid electrolyte may be a crystalline argyrodite solid electrolyte. The crystalline argyrodite solid electrolyte may be obtained by heat treatment at a temperature of 550° C. or greater. For example, the crystalline argyrodite solid electrolyte may include Li₇₋ₓPS₆₋ₓClₓ wherein 0<x<2; Li₇₋ₓPS₆₋ₓBrₓ wherein 0<x<2; Li₇₋ₓPS₆₋ₓIₓ wherein 0<x<2; or a combination thereof. For example, the crystalline argyrodite solid electrolyte may include Li₆PS₅Cl, Li₆PS₅Br, Li₆PS₅I, or a combination thereof. The modulus of elasticity of the crystalline argyrodite-based solid electrolyte may be, for example, 30 gigapascal (GPa) or greater.

The solids content of the solid electrolyte slurry may be about 50 wt % to about 70 wt %, based on total weight of the solid electrolyte slurry. If the solids content of the solid electrolyte slurry is within the above range, the solid electrolyte slurry may maintain good viscosity stability during film formation to thus enable desirable film formation. The viscosity of the solid electrolyte slurry appropriate for such desirable film formation may be about 1,000 centipoise (cP) to about 7,000 cP and may be for example, about 3,000 cP to about 5,000 cP.

The solid electrolyte slurry may further include a dispersing agent, a leveling agent, a defoaming agent, or a combination thereof.

For the dispersing agent, an anionic compound, a cationic compound, a non-ionic compound, a polymer compound, or a combination thereof, may be used. The dispersing agent may be chosen depending on the sulfide-containing solid electrolyte used. The content of the dispersing agent in the solids content of the solid electrolyte slurry may be, within a range that does not affect battery characteristics, about 10 parts by weight or less, based on 100 parts by weight of sulfide-containing solid electrolyte.

For the leveling agent, an alkyl-containing surfactant, a silicon-containing surfactant, a fluorine-containing surfactant, a metal-containing surfactant, or the like, or a combination thereof, may be used. By mixing with such a surfactant, the flatness may be improved by preventing cratering from occurring while coating solid electrolyte slurry. The content of the leveling agent in the solids content of the solid electrolyte slurry may be, within a range that does not affect battery characteristics, about 10 parts by weight or less, based on 100 parts by weight of sulfide-containing solid electrolyte.

For the defoaming agent, a mineral oil-containing defoaming agent, a silicon-containing defoaming agent, a polymer-containing defoaming agent, or the like, or a combination thereof, may be used. The defoaming agent may be chosen depending on the sulfide-containing solid electrolyte that is used. The content of the defoaming agent in the solids content of the solid electrolyte slurry may be, within a range that does not affect battery characteristics, about 10 parts by weight or less based on 100 parts by weight of sulfide-containing solid electrolyte.

The content of the sulfide-containing solid electrolyte may be about 90 parts by weight to about 99.9 parts by weight, based on 100 parts by weight of the solid electrolyte layer. That is, the sulfide-containing solid electrolyte may be present in an amount of about 90 parts by weight to about 99.9 parts by weight, based on 100 parts by weight of the solid electrolyte layer. If the content of the sulfide-containing solid electrolyte is less than about 90 parts by weight, the solid electrolyte layer may have a reduced ionic conductivity due to increased resistance. If the content of the sulfide-containing solid electrolyte exceeds about 99.9 parts by weight, the binding force between solid electrolytes may be decreased, thus causing the solid electrolyte layer to break more easily.

The content of the binder may be about 0.1 parts by weight to about 10 parts by weight, based on 100 parts by weight of the solid electrolyte layer. That is, the binder may be present in an amount of about 0.1 parts by weight to about 10 parts by weight, based on 100 parts by weight of the solid electrolyte layer. When the content of the binder is less than about 0.1 parts by weight, the binding force of the solid electrolyte layer may deteriorate. When the content of the binder exceeds about 10 parts by weight, the binder may act as an electrical resistance and thus cause a decrease in ionic conductivity and a deterioration of the battery performance.

The solid electrolyte layer may have a thickness of about 10 micrometers (μm) to about 150 μm. For example, the solid electrolyte layer may have a thickness of about 15 μm to about 125 μm, or about 20 μm to about 100 μm, without being limited thereto.

The solid electrolyte layer may have an ionic conductivity of about 0.1 millisiemens per centimeter (mS/cm) to about 5 mS/cm, when measured at 25° C. For example, the solid electrolyte layer may have an ionic conductivity of about 0.15 mS/cm to about 5 mS/cm, about 0.2 mS/cm to about 4 mS/cm, about 0.25 mS/cm to about 4 mS/cm, about 0.3 mS/cm to about 3 mS/cm, or about 0.34 mS/cm to about 3 mS/cm, when measured at 25° C. By having an ionic conductivity at 25° C. in the above ranges, the solid electrolyte layer may be applicable as an electrolyte layer of an all-solid battery.

An electrode according to another embodiment may include an electrode current collector; and an electrode active material layer disposed on the electrode current collector, wherein the electrode active material layer may be formed using an electrode active material slurry that includes an electrode active material, a sulfide-containing solid electrolyte, the above-described solvent, a conductive material, and a binder.

For example, the electrode may be a cathode. The cathode may include a cathode current collector and a cathode active material layer disposed on the cathode current collector.

The cathode current collector may utilize a plate, a foil, or the like, and may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), an alloy thereof, or a combination thereof. The cathode current collector may be omitted in some embodiments.

For the cathode active material, any suitable compound capable of intercalation/deintercalation of lithium that is commonly used in the art, e.g., alkaline metals, may be used without limitation.

Non-limiting examples of the compound capable of intercalation/deintercalation of lithium may include a compound represented by LiₐA_{1-b}B′_{b}D′₂ (wherein 0.90≤a≤1.8, and 0≤b≤0.5); LiₐE_{1-b}B′_{b}O_{2-c}D′_{c} (wherein 0.90≤a≤1.8, 0≤b≤0.5, and 0≤c≤0.05); LiE_{2-b}B′_{b}O_{4-c}D′_{c} (wherein 0≤b≤0.5, and 0≤c≤0.05); LiₐNi_{1-b-c}Co_{b}B′_{c}D′_{α} (wherein 0.90≤a≤1.8, 0≤b≤0.5, 0≤c≤0.05, and 0<α≤2); LiₐNi_{1-b-c}Co_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}D′_{α} (wherein 0.90≤a≤1.8, 0≤b≤0.5, 0≤c≤0.05, and 0<α≤2); LiₐNi_{1-b-c}Mn_{b}B′_{c}O₂₋ₐF′_{α}. (wherein 0.90≤a≤1.8, 0≤b≤0.5, 0≤c≤0.05, and 0<α≤2); LiₐNi_{b}E_{c}G_{f}O₂ (wherein 0.90≤a≤1.8, 0≤b≤0.9, 0≤c≤0.5, and 0.001≤f≤0.1); LiₐNi_{b}Co_{c}Mn_{d}G_{f}O₂ (wherein 0.90≤a≤1.8, 0≤b≤0.9, 0≤c≤0.5, 0≤d≤0.5, and 0.001≤f≤0.1); LiₐNiG_{b}O₂ (wherein 0.90≤a≤1.8, and 0.001≤b≤0.1); LiₐCoG_{b}O₂ (wherein 0.90≤a≤1.8, and 0.001≤b≤0.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiIO₂; LiNiVO₄; Li_{(3-f)}J₂ (PO₄)₃ (wherein 0≤f≤2); Li_{(3-f)}Fe₂(PO₄)₃ (wherein 0≤f≤2); LiFePO₄, or a combination thereof.

In the above chemical formulae, A may be Ni, Co, Mn, or a combination thereof; B′ may be Al, Ni, Co, Mn, Cr, Fe, Mg, Sr, V, a rare-earth element, or a combination thereof; D′ may b′ O, F, S, P, a combination thereof; E may be Co, Mn, a combination thereof; F′ may be F, S, P, a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof.

Non-limiting examples of the cathode active material may include a ternary lithium transition metal oxide, such as LiNiₓCo_{y}Mn_{z}O₂ (NCM) (wherein 0<x<1, 0<y<1, 0<z<1, while x+y+z=1) or LiNiₓCo_{y}Al_{z}O₂ (NCA), having a layered rock salt structure. The ternary lithium transition metal oxide having a layered rock salt structure may improve energy density and thermal stability of an all-solid battery.

In one or more embodiments, any of the aforementioned cathode active materials may have a coating layer on a surface thereof. Alternatively, a mixture of any one or more of the aforementioned cathode active materials and a cathode active material having a coating layer may also be used. The coating layer may include at least coating element compound, such as an oxide, a hydroxide, an oxyhydroxide, an oxycarbonate, or a hydroxycarbonate of a coating element. The compound for forming such a coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer may be formed using any suitable coating method that is capable of coating the cathode active material when a compound of the coating element is used, without an adverse effect on physical properties of the cathode active material. For example, the coating layer may be formed by spray coating, precipitation coating, or the like. These methods are understood by those skilled in the art, and thus a detailed description thereof is omitted.

The cathode active material may utilize a nickel-based composite oxide, such as lithium nickel cobalt aluminum oxide and nickel cobalt lithium manganate including nickel in an amount of about 60 wt % or greater, about 75 wt % or greater, or about 90 wt % or greater. The cathode active material including nickel in the above ranges rarely generates resistance components between sulfide-containing solid electrolytes, and thus can help ensure ionic conductivity.

Other than the above nickel-containing composite oxides, the cathode active material may utilize a lithium cobalt oxide having a large true density and a high lithium ion diffusion rate. For example, the cathode active material may utilize a composite cathode active material, such as a lithium cobalt oxide coated with a nickel-based composite oxide, LiNbO₂, Li₄Ti₅O₁₂, an aluminum oxide, or the like, or a combination thereof.

The shape of the cathode active material may be, for example, a particle shape such as a true spherical shape or an elliptical spherical shape. In addition, the particle diameter of the cathode active material is not particularly limited and may be in a range applicable to cathode active materials of common all-solid batteries.

The content of the cathode active material in the cathode also is not particularly limited and may be in a range applicable to cathodes of common all-solid batteries.

The cathode active material layer may further include a conductive material and a binder in addition to the above-mentioned cathode active material, solid electrolyte, and solvent. Non-limiting examples of the conductive material may include graphite, carbon black (CB), acetylene black (AB), Ketjen black (KB), a carbon nanotube, a carbon fiber, a metal powder, or the like, or a combination thereof. Non-limiting examples of the binder that can be blended with the cathode active material layer may include styrene butadiene rubber (SBR), polytetrafluoroethylene, polyvinylidene fluoride, polyethylene, or the like, or a combination thereof.

A coating agent, a dispersing agent, or an ionic conductivity aid, or the like that may be blended with the cathode may be further included. For the aforementioned components, known materials commonly used in electrodes of all-solid batteries may be used in an appropriate amount.

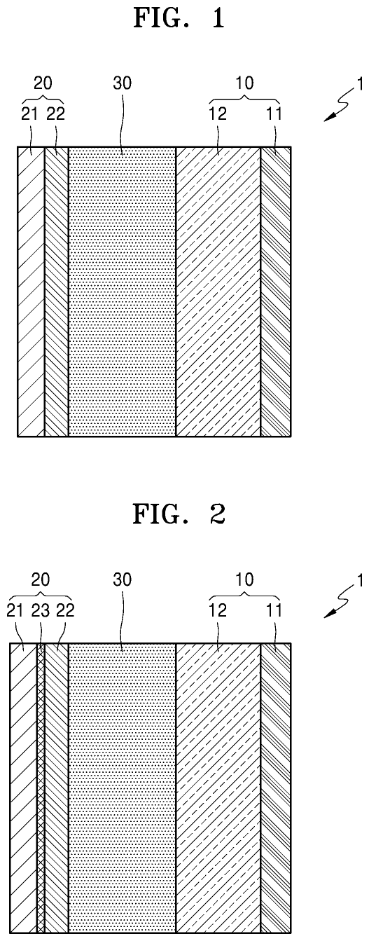

FIG. 1 is a cross-sectional view of an all-solid battery according to one or more embodiments. FIG. 2 is a cross-sectional view of an all-solid battery according to another embodiment.

Referring to FIG. 1 and FIG. 2, an all-solid battery 1 according to one or more embodiments may include a cathode 10; an anode 20, and a solid electrolyte layer 30 disposed between the cathode and the anode, wherein the anode 20 may include an anode current collector 21 and a first anode active material layer 22, and a second anode active material layer 23 may be further disposed between the anode current collector 21 and the first anode active material layer 22. The cathode 10 may be the above-described cathode, including a cathode current collector (11) and a cathode active material layer (12). Alternatively, the cathode 10 may have an electrode active material layer formed using an electrode active material slurry that includes an electrode active material excluding a sulfide-containing solid electrolyte, the aforementioned solvent, a conductive material, and a binder.

The anode current collector 21 of the anode 20 may be formed of a material that does not react with nor form alloys or compounds with alkaline metals, e.g., lithium metal. Examples of the material forming the anode current collector 21 may include copper (Cu), stainless steel, titanium (Ti), iron (Fe), cobalt (Co), nickel (Ni), or a combination thereof. The anode current collector 21 may include one of the aforementioned metals, an alloy of two or more of the aforementioned metals, or a coating material. The anode current collector 21 may be formed, for example, in a plate shape or a thin film shape.

The first anode active material layer 22 and the second anode active material layer 23 may be the same material, or the first anode active material layer 22 and the second anode active material layer 23 may be different materials from each other. Anode active material used in the first anode active material layer 22 and the second anode active material layer 23 may include a metal-containing anode active material, a carbon-containing anode active material, or an anode active material that includes a combination thereof. Examples of the metal-containing anode active material may include lithium, or an alloy of lithium including one or more of indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), palladium (Pd), silver (Ag), zinc (Zn), or a combination thereof. However, the metal-containing anode active material is not limited to the aforementioned components and may utilize any suitable metal or metalloid usable in the art that is capable of forming an alloy with lithium. For example, as a carbon-containing anode active material, graphite, carbon black (CB), acetylene black (AB), furnace black (FB), Ketjen black (KB), graphene, a carbon nanotube, or a carbon nanofiber, or the like, or a combination thereof may be used. The first anode active material layer 22 and the second anode active material layer 23 may include an appropriate combination of additives, such as one or more of a conductive material, a binder, a filler, a dispersion agent, an ionic conductivity aid, or the like, or a combination thereof. In some embodiments, the first anode active material layer 22 may be an anode-free coating layer. For example, the anode-free coating layer may contain carbon and a metal such as silver and silicon, and have a structure in which a binder is disposed around the metal and the carbon. The anode-free coating layer may have a thickness of about 1 μm to about 20 μm.

The solid electrolyte layer 30 may be a solid electrolyte layer formed using a solid electrolyte slurry including the above-described sulfide-containing solid electrolyte, the above-described solvent, and a binder. The all-solid battery 1 may be safe and have a high energy density.

Hereinbelow, Examples and Comparative Examples will be described in further detail. However, the following examples are non-limiting and are for illustrative purposes only.

### EXAMPLES

### Preparation Example 1: Solid Electrolyte Slurry

In a glove box under an argon atmosphere, LiCL (purity: 99.9%, Aldrich), Li₂S (purity: 99.9%, Mitsuwa Chemicals), and P₂S₅ (purity: 99%, Aldrich) were weighed at stoichiometric molar ratios to produce a Li₆PS₅Cl sulfide solid electrolyte, and were combined to form a mixture.

Under an argon atmosphere, the mixture and zirconia balls (diameter: 5 millimeters (mm)) were introduced into a vessel, and the contents were mechanically milled for 1 hour at room temperature, and then mechanochemically reacted to produce a precursor.

The precursor was introduced into an aluminum crucible and heated at 330° C. for 12 hours under an argon atmosphere, and then was subsequently heated at a temperature of 400° C. to 600° C. for 12 hours. The contents were then cooled to room temperature and recovered to thereby produce a crystalline argyrodite solid electrolyte, Li₆PS₅Cl.

The argyrodite sulfide solid electrolyte Li₆PS₅Cl (98 parts by weight), a hydrogenated nitrile-butadiene rubber binder (1.3 parts by weight), a non-ionic dispersing agent (CRODA, Hypermer KD13) (0.7 parts by weight), and 2-ethylhexyl acetate (66.64 parts by weight) were placed in a Nalgene container and mixed using a paste mixer, to prepare a solid electrolyte slurry having a solids content of about 60 wt %, based on the total weight of the solid electrolyte slurry.

### Preparation Example 2: Solid Electrolyte Slurry

A solid electrolyte slurry having a solids content of about 60 wt % was prepared following a similar process as in Preparation Example 1, except that 66.64 parts by weight of hexyl acetate was used instead of 66.64 parts by weight of 2-ethylhexyl acetate.

### Preparation Example 3: Solid Electrolyte Slurry

A solid electrolyte slurry having a solids content of about 60 wt % was prepared following a similar process as in Preparation Example 1, except that 66.64 parts by weight of isopropylbenzene was used instead of 66.64 parts by weight of 2-ethylhexyl acetate.

### Preparation Example 4: Solid Electrolyte Slurry

A solid electrolyte slurry having a solids content of about 60 wt % was prepared following a similar process as in Preparation Example 1, except that 66.64 parts by weight of isobutyl isobutyrate was used instead of 66.64 parts by weight of 2-ethylhexyl acetate.

### Preparation Example 5: Solid Electrolyte Slurry

A solid electrolyte slurry having a solids content of about 60 wt % was prepared following a similar process as in Preparation Example 1, except that 66.64 parts by weight of n-butyl butyrate was used instead of 66.64 parts by weight of 2-ethylhexyl acetate.

### Preparation Example 6: Solid Electrolyte Slurry

A solid electrolyte slurry having a solids content of about 60 wt % was prepared following a similar process as in Preparation Example 1, except that 66.64 parts by weight of ethyl hexanoate was used instead of 66.64 parts by weight of 2-ethylhexyl acetate.

### Preparation Example 7: Solid Electrolyte Slurry

A solid electrolyte slurry having a solids content of about 60 wt % was prepared following a similar process as in Preparation Example 1, except that 66.64 parts by weight of diisobutyl ketone was used instead of 66.64 parts by weight of 2-ethylhexyl acetate.

### Preparation Example 8: Solid Electrolyte Slurry

A solid electrolyte slurry having a solids content of about 60 wt % was prepared following a similar process as in Preparation Example 1, except that 66.64 parts by weight of n-heptyl acetate was used instead of 66.64 parts by weight of 2-ethylhexyl acetate.

### Preparation Example 9: Solid Electrolyte Slurry

A solid electrolyte slurry having a solids content of about 60 wt % was prepared following a similar process as in Preparation Example 1, except that 66.64 parts by weight of d-limonene was used instead of 66.64 parts by weight of 2-ethylhexyl acetate.

### Preparation Example 10: Solid Electrolyte Slurry

A solid electrolyte slurry having a solids content of about 60 wt % was prepared following a similar process as in Preparation Example 1, except that 66.64 parts by weight of trimethylbenzene was used instead of 66.64 parts by weight of 2-ethylhexyl acetate.

### Comparative Preparation Example 1: Solid Electrolyte Slurry

A solid electrolyte slurry having a solids content of about 60 wt % was prepared following a similar process as in Preparation Example 1, except that 66.64 parts by weight of xylene was used instead of 66.64 parts by weight of 2-ethylhexyl acetate.

### Comparative Preparation Example 2: Solid Electrolyte Slurry

A solid electrolyte slurry having a solids content of about 60 wt % was prepared following a similar process as in Preparation Example 1, except that 66.64 parts by weight of n-methyl-2-pyrrolidone was used instead of 66.64 parts by weight of 2-ethylhexyl acetate.

### Comparative Preparation Example 3: Solid Electrolyte Slurry

A solid electrolyte slurry having a solids content of about 60 wt % was prepared following a similar process as in Preparation Example 1, except that 66.64 parts by weight of n-butyl acetate was used instead of 66.64 parts by weight of 2-ethylhexyl acetate.

### Comparative Preparation Example 4: Solid Electrolyte Slurry

A solid electrolyte slurry having a solids content of about 60 wt % was prepared following a similar process as in Preparation Example 1, except that 66.64 parts by weight of ethylbenzene was used instead of 66.64 parts by weight of 2-ethylhexyl acetate.

### Comparative Preparation Example 5: Solid Electrolyte Slurry

A solid electrolyte slurry having a solids content of about 60 wt % was prepared following a similar process as in Preparation Example 1, except that 66.64 parts by weight of 1,1-dichloroethane was used instead of 66.64 parts by weight of 2-ethylhexyl acetate.

### Comparative Preparation Example 6: Solid Electrolyte Slurry

A solid electrolyte slurry having a solids content of about 60 wt % was prepared following a similar process as in Preparation Example 1, except that 66.64 parts by weight of heptane was used instead of 66.64 parts by weight of 2-ethylhexyl acetate.

### Comparative Preparation Example 7: Solid Electrolyte Slurry

A solid electrolyte slurry having a solids content of about 60 wt % was prepared following a similar process as in Preparation Example 1, except that 66.64 parts by weight of octyl acetate was used instead of 66.64 parts by weight of 2-ethylhexyl acetate.

### Comparative Preparation Example 8: Solid Electrolyte Slurry

A solid electrolyte slurry having a solids content of about 60 wt % was prepared following a similar process as in Preparation Example 1, except that 66.64 parts by weight of toluene was used instead of 66.64 parts by weight of 2-ethylhexyl acetate.

### Preparation Example 11: Cathode Active Material Slurry

A cathode active material LiNi_{0.8}Co_{0.15}Mn_{0.05}O₂ (85 parts by weight), the argyrodite sulfide solid electrolyte Li₆PS₅Cl used in Preparation Example 1 (15 parts by weight), a hydrogenated nitrile-butadiene rubber binder (1.2 parts by weight), a carbon nanofiber conductive material (0.2 parts by weight), and 2-ethylhexyl acetate (50 parts by weight) were placed in a Nalgene container and mixed using a paste mixer to prepare a cathode active material slurry having a solids content of about 67 wt %.

### Preparation Example 12: Cathode Active Material Slurry

A cathode active material slurry having a solids content of about 67 wt % was prepared following a similar process as in Preparation Example 11, except that 50 parts by weight of hexyl acetate was used instead of 50 parts by weight of 2-ethylhexyl acetate.

### Preparation Example 13: Cathode Active Material Slurry

A cathode active material slurry having a solids content of about 67 wt % was prepared following a similar process as in Preparation Example 11, except that 50 parts by weight of isopropylbenzene was used instead of 50 parts by weight of 2-ethylhexyl acetate.

### Preparation Example 14: Cathode Active Material Slurry

A cathode active material slurry having a solids content of about 67 wt % was prepared following a similar process as in Preparation Example 11, except that 50 parts by weight of isobutyl isobutyrate was used instead of 50 parts by weight of 2-ethylhexyl acetate.

### Preparation Example 15: Cathode Active Material Slurry

A cathode active material slurry having a solids content of about 67 wt % was prepared following a similar process as in Preparation Example 11, except that 50 parts by weight of n-butyl butyrate was used instead of 50 parts by weight of 2-ethylhexyl acetate.

### Preparation Example 16: Cathode Active Material Slurry

A cathode active material slurry having a solids content of about 67 wt % was prepared following a similar process as in Preparation Example 11, except that 50 parts by weight of ethyl hexanoate was used instead of 50 parts by weight of 2-ethylhexyl acetate.

### Preparation Example 17: Cathode Active Material Slurry

A cathode active material slurry having a solids content of about 67 wt % was prepared following a similar process as in Preparation Example 11, except that 50 parts by weight of diisobutyl ketone was used instead of 50 parts by weight of 2-ethylhexyl acetate.

### Preparation Example 18: Cathode Active Material Slurry

A cathode active material slurry having a solids content of about 67 wt % was prepared following a similar process as in Preparation Example 11, except that 50 parts by weight of n-heptyl acetate was used instead of 50 parts by weight of 2-ethylhexyl acetate.

### Preparation Example 19: Cathode Active Material Slurry

A cathode active material slurry having a solids content of about 67 wt % was prepared following a similar process as in Preparation Example 11, except that 50 parts by weight of d-limonene was used instead of 50 parts by weight of 2-ethylhexyl acetate.

### Preparation Example 20: Cathode Active Material Slurry

A cathode active material slurry having a solids content of about 67 wt % was prepared following a similar process as in Preparation Example 11, except that 50 parts by weight of trimethylbenzene was used instead of 50 parts by weight of 2-ethylhexyl acetate.

### Example 1: Solid Electrolyte Layer

A nonwoven-fabric separator having a thickness of 8 μm and 90% porosity was attached and fixed to a release film. The solid electrolyte slurry of Preparation Example 1 was poured onto the non-woven fabric and coated by doctor blade coating, followed by drying at 80° C. in a convection oven and vacuum-drying at 70° C. for 2 hours in a vacuum oven, to thereby produce a solid electrolyte layer having a thickness of about 95 μm.

### Examples 2 to 10: Solid Electrolyte Layers

Solid electrolyte layers having a thickness of about 95 μm were prepared using a similar process as for Example 1, except that each of the solid electrolyte slurries of Preparation Examples 2 to 10 was used in place of the solid electrolyte slurry of Preparation Example 1.

### Comparative Examples 1 to 8: Solid Electrolyte Layers

Solid electrolyte layers having a thickness of about 95 μm were prepared using a similar process as for Example 1, except that each of the solid electrolyte slurries of Comparative Preparation Examples 2 to 10 was used in place of the solid electrolyte slurry of Preparation Example 1.

The characteristics of the solvents used for the solid electrolyte slurries of Preparation Examples 1 to 10 and Comparative Preparation Examples 1 to 8, and for the cathode active material slurries of Preparation Examples 11 to 20 are summarized in Tables 1A and 1B below. In Table 1A below, “1(11)” indicates, for example, the data for Preparation Examples 1 and 11.

Here, “HSP, δ” represents “Hansen solubility parameter”, “δD” represents “dispersion energy parameter”, “δ” represents “polar-dipolar energy parameter”, “δH” represents “hydrogen bond energy parameter”, “HSP D” (2-EHA)” represents “Hansen solubility parameter distance for 2-ethylhexyl acetate”, “HSP D (xylene)” represents “Hansen solubility parameter distance for xylene”, “b.p.” represents “boiling point”, and “f.p.” represents “flash point”.

The Hansen solubility parameter (δ) values were calculated according to Equation 1 by using a program called HSPiP (Hansen Solubility Parameters in Practice) developed by the Hansen Group.

δ²=(δD)²+(δP)²+(δH)² Equation 1

wherein, in Equation 1, δ is about 16.4 Mpa^{1/2} to about 18.2 Mpa^{1/2}, δD is about 15 Mpa^{1/2} to about 18.2 Mpa^{1/2}, δP is about 0 Mpa^{1/2} to about 4 Mpa^{1/2}, and δH is about 0 Mpa^{1/2} to about 6 Mpa^{1/2}.

The Hansen solubility parameter distances (Ra) were calculated by Equation 2 using δD₁, δP₁, and δH₁ values of 2-ethylhexyl acetate or xylene, and δD₂, δP₂, and δH₂ values of a solvent other than 2-ethylhexyl acetate and xylene.

Ra²=4(δD₁−δD₂)²+(δP₁−δP₂)²+(δH₁−δH₂)² Equation 2]

For vapor pressure, b.p., and f.p. values from Material Safety Data Sheet (MSDS) of the manufacturer and the literature were used.

TABLE 1A

| | Prep. | Prep. | Prep. | Prep. | Prep. | Prep. | Prep. | Prep. | Prep. | Prep. |
|---|---|---|---|---|---|---|---|---|---|---|
| | Ex. | Ex. | Ex. | Ex. | Ex. | Ex. | Ex. | Ex. | Ex. | Ex. |
| | 1(11) | 2(12) | 3(13) | 4(14) | 5(15) | 6(16) | 7(17) | 8(18) | 9(19) | 10(20) |
| Solvent | 2-ethyl | hexyl | isopropyl | isobutyl | n-butyl | ethyl | di-isobutyl | n-heptyl | d-limonene | trimethyl- |
| | hexyl acetate | acetate | benzene | iso-butyrate | butyrate | hexanoate | ketone | acetate | | benzene |
| HSP, δ (MPa^{1/2}) | 16.85 | 17.11 | 18.18 | 16.42 | 16.83 | 16.89 | 16.93 | 16.98 | 17.82 | 18.06 |
| δD (MPa^{1/2}) | 15.8 | 15.8 | 18.1 | 15.1 | 15.6 | 15.5 | 16.0 | 15.8 | 17.2 | 18.0 |
| δP (MPa^{1/2}) | 2.9 | 2.9 | 1.2 | 2.8 | 2.9 | 3.2 | 3.7 | 2.9 | 1.8 | 1.0 |
| δH (MPa^{1/2}) | 5.1 | 5.9 | 1.2 | 5.8 | 5.6 | 5.9 | 4.1 | 5.5 | 4.3 | 1.0 |
| HSP D (2-EHA) (MPa^{1/2}) | 0 | 0.64 | 39.26 | 2.46 | 0.41 | 1.09 | 1.80 | 0.16 | 9.69 | 39.78 |
| HSP D (Xylene) (MPa^{1/2}) | 23.61 | 27.45 | 4.01 | 39.69 | 29.22 | 33.84 | 21.25 | 25.37 | 3.52 | 4.57 |
| vapor pressure | 30.66 | 175.99 | 599.95 | 577.29 | 241.31 | 207.98 | 219.98 | 67.99 | 263.98 | 279.98 |
| (@25° C.) (Pa) | | | | | | | | | | |
| b.p (° C.) | 199.0 | 171.5 | 152.4 | 147.0 | 166.0 | 167.0 | 168.0 | 193.0 | 176 | 169 |
| f.p (° C.) | 71.0 | 45.0 | 31.0 | 37.2 | 49.0 | 49.4 | 49.0 | 67.8 | 48 | 44 |

TABLE 1B

| | Comp. | Comp. | Comp. | Comp. | Comp. | Comp. | Comp. | Comp. |
|---|---|---|---|---|---|---|---|---|
| | Prep. | Prep. | Prep. | Prep. | Prep. | Prep. | Prep. | Prep. |
| | Ex. 1 | Ex. 2 | Ex. 3 | Ex. 4 | Ex. 5 | Ex. 6 | Ex. 7 | Ex. 8 |
| Solvent | xylene | n-methyl- | n-butyl | ethyl | 1,1- | heptane | octyl | toluene |
| | | 2-pyrrolidone | acetate | benzene | dichloroethane | | acetate | |
| HSP, δ | 18.10 | 22.96 | 17.41 | 17.87 | 18.50 | 15.30 | 16.85 | 18.16 |
| (MPa^{1/2}) | | | | | | | | |
| δD (MPa^{1/2}) | 17.8 | 18.0 | 15.8 | 17.8 | 16.5 | 15.3 | 15.8 | 18.0 |
| δP (MPa^{1/2}) | 1.0 | 12.3 | 3.7 | 0.6 | 7.8 | 0 | 2.9 | 1.4 |
| δH (MPa^{1/2}) | 3.1 | 7.2 | 6.3 | 1.4 | 3.0 | 0 | 5.1 | 2.0 |
| HSP D (2-EHA) (MPa^{1/2}) | 23.61 | 112.13 | 2.08 | 34.98 | 30.38 | 35.42 | 0 | 31.22 |
| HSP D (Xylene) (MPa^{1/2}) | 0 | 144.66 | 33.53 | 3.05 | 53.01 | 35.61 | 23.61 | 1.53 |
| vapor pressure | 1178.57 | 45.33 | 1533.21 | 1279.89 | 30264.2 | 6132.83 | 25.86 | 3786.36 |
| (@25° C.) (Pa) | | | | | | | | |
| b.p (° C.) | 139.0 | 202.0 | 126 | 136.0 | 57.0 | 98.4 | 210.0 | 110.6 |
| f.p (° C.) | 27.2 | 91.0 | 22 | 15.0 | −6.0 | −7.0 | 81.7 | 4.0 |

### Evaluation Example 1: Viscosity Change of Solid Electrolyte Slurry and Film Forming Characteristics

Viscosity changes in the solid electrolyte slurries used in the solid electrolyte layers of Examples 1 to 10 and Comparative Examples 1 and 2, and film forming characteristics of the solid electrolyte layers were evaluated with a naked eye. The results thereof are shown in Table 2 below.

TABLE 2

| | | Viscosity change of | Film forming |
|---|---|---|---|
| | Solvent | solid electrolyte slurry | characteristics |
| Example 1 | 2-Ethylhexyl acetate | Slurry viscosity | Excellent slurry viscosity |
| | | remained stable | and solids retention |
| | | (3,000-5,000 cP) | characteristics due to low |
| | | | solvent evaporation |
| Example 2 | Hexyl acetate | Slurry viscosity | Excellent slurry viscosity |
| | | remained stable | and solids retention |
| | | (3,000-5,000 cP) | characteristics due to low |
| | | | solvent evaporation |
| Example 3 | Isopropylbenzene | Slurry viscosity | Good slurry viscosity and |
| | | remained stable | solids retention |
| | | (3,000-5,000 cP) | characteristics due to |
| | | | lower volatility than |
| | | | xylene |
| Example 4 | Isobutyl isobutyrate | Slurry viscosity | Good slurry viscosity and |
| | | remained stable | solids retention |
| | | (3,000-5,000 cP) | characteristics due to |
| | | | lower volatility than |
| | | | xylene |
| Example 5 | n-Butyl butyrate | Slurry viscosity | Good slurry viscosity and |
| | | remained stable | solids retention |
| | | (3,000-5,000 cP) | characteristics due to |
| | | | lower volatility than |
| | | | xylene |
| Example 6 | Ethyl hexanoate | Slurry viscosity | Good slurry viscosity and |
| | | remained stable | solids retention |
| | | (3,000-5,000 cP) | characteristics due to |
| | | | lower volatility than |
| | | | xylene |
| Example 7 | Diisobutyl ketone | Slurry viscosity | Good slurry viscosity and |
| | | remained stable | solids retention |
| | | (3,000-5,000 cP) | characteristics due to |
| | | | lower volatility than |
| | | | xylene |
| Example 8 | n-Heptyl acetate | Slurry viscosity | Excellent slurry viscosity |
| | | remained stable | and solids retention |
| | | (3,000-5,000 cP) | characteristics due to low |
| | | | solvent evaporation |
| Example 9 | d-Limonene | Slurry viscosity | Excellent slurry viscosity |
| | | remained stable | and solids retention |
| | | (3,000-5,000 cP) | characteristics due to low |
| | | | solvent evaporation |
| Example 10 | Trimethylbenzene | Slurry viscosity | Good slurry viscosity and |
| | | remained stable | solids retention |
| | | (3,000-5,000 cP) | characteristics due to |
| | | | lower volatility than |
| | | | xylene |
| Comparative | Xylene | Shear thickening | Unstable slurry viscosity |
| Example 1 | | occurred | due to rapid solvent |
| | | | evaporation |
| Comparative | n-Methyl-2-pyrrolidone | Unable to prepare | Unable to form film |
| Example 2 | | slurry due to reaction | |
| | | with solid electrolyte | |

Referring to Table 2, the viscosity of the solid electrolyte slurry used in the solid electrolyte layers of Examples 1 to 10 remained stable from about 3,000 cP to about 5,000 cP, and during film formation with the solid electrolyte slurry, there was little solvent evaporation, thus exhibiting excellent slurry viscosity and solids content retention characteristics.

Meanwhile, the solid electrolyte slurry used in the solid electrolyte layer of Comparative Example 1 showed shear thickening, and showed unstable slurry viscosity due to rapid solvent evaporation during film formation with the solid electrolyte slurry. With the solid electrolyte slurry used in the solid electrolyte layer of Comparative Example 2, a slurry could not be prepared due to reactions with solid electrolyte, and consequently, no film could be formed.

These results confirmed that the solid electrolyte slurries used in the solid electrolyte layers of Examples 1 to 10 have lower reactivity with the solid electrolyte and lower solvent evaporation, and therefore can maintain stable viscosity and show excellent film forming characteristics.

### Evaluation Example 2: Ionic Conductivity

An electron-blocking cell was prepared by stacking together 10 sheets of each of the solid electrolyte layers of Examples 1 to 5 and Comparative Examples 1 and 2, and attaching an indium film to the upper and lower surfaces of the solid electrolyte layer, followed by compression by a pressure of 4 tons. Then, ionic conductivity of the ion-blocking cell was measured at 25° C. using a direct current (DC) polarization method. The results thereof are shown in Table 3, where the ionic conductivity was measured at 25° C.

TABLE 3

| | | Ionic |
|---|---|---|
| | | conductivity |
| | Solvent | (mS/cm) |
| Example 1 | 2-Ethylhexyl acetate | 0.38 |
| Example 2 | Hexyl acetate | 0.34 |
| Example 3 | Isopropylbenzene | 0.35 |
| Example 4 | Isobutyl isobutyrate | 0.42 |
| Example 5 | n-Butyl butyrate | 0.40 |
| Comparative | Xylene | 0.41 |
| Example 1 | | |
| Comparative | n-Methyl-2-pyrrolidone | Unable to |
| Example 2 | | measure |

Referring to Table 3, ionic conductivities at 25° C. of the solid electrolyte layers of Examples 1 to 5 were between 0.34 mS/cm and 0.42 mS/cm. Meanwhile, ionic conductivity could not be measured for the solid electrolyte layer of Comparative Example 2 since reactions with the solid electrolyte made slurry preparation and film formation impossible. From here, it was confirmed that the solid electrolyte layers of Examples 1 to 5 have excellent ionic conductivity at 25° C.

A solvent for preparing a solid electrolyte layer according to an aspect may have a vapor pressure of about 26.66 Pascal (0.2 mmHg) to about 600 Pascal (4.5 mmHg) at 25° C., and may satisfy Equation 1 wherein, in the Hansen solubility parameter equation, δ is about 16.4 MPa^{1/2} to about 18.2 MPa^{1/2}, δD is about 15 MPa^{1/2} to about 18.2 MPa^{1/2} δP is about 0 MPa^{1/2} to about 4 MPa^{1/2}, δH is about 0 MPa^{1/2} to about 6 MPa^{1/2}. A binder composition containing the above solvent, and a solid electrolyte layer formed using the above solvent, may exhibit lower reactivity with a solid electrolyte, and thus allow viscosity of the slurry to remain stable during film formation and provide excellent film forming characteristics while maintaining high ionic conductivity. An electrode and an all-solid battery, formed using the above solvent, may be safe and have a high energy density.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments. While one or more exemplary embodiments have been described with reference to the figures, it will be understood by those of ordinary skill in the art that various changes in form and details may be made therein without departing from the spirit and scope as defined by the following claims.

What is claimed is:

1. A solvent for preparing a solid electrolyte layer,
wherein the solvent has a vapor pressure of about 26.66 Pascal to about 600 Pascal at 25° C., and
wherein the solvent satisfies Equation 1,
δ²=(δD)²+(δP)²+(δH)² Equation 1
wherein, in Equation 1,
δ is a Hansen solubility parameter, and δ is about 16.4 Mpa^{1/2} to about 18.2 Mpa^{1/2},
δD is a dispersion energy parameter, and δD is about 15 Mpa^{1/2} to about 18.2 Mpa^{1/2},
δP is a polar-dipolar energy parameter, and δP is about 0 Mpa^{1/2} to about 4 Mpa^{1/2}, and
δH is a hydrogen bonding energy parameter, and δH is about 0 Mpa^{1/2} to about 6 Mpa^{1/2}:

2. The solvent of claim 1, wherein the solvent further satisfies Equation 2:
Ra²=4(δD₁−δD₂)²+(δP₁−δP₂)²+(δH₁−δH₂)² Equation 2
wherein in Equation 2,
Ra is a Hansen solubility parameter distance,
δD₁ is a dispersion energy parameter for 2-ethylhexyl acetate or xylene,
δD₂ is a dispersion energy parameter for the solvent,
δP₁ is a polar-dipolar energy parameter for 2-ethylhexyl acetate or xylene,
δP₂ is a polar-dipolar energy parameter for the solvent,
δH₁ is a hydrogen bonding energy parameter for 2-ethylhexyl acetate or xylene, and
δH₂ is a hydrogen bonding energy parameter for the solvent,
wherein Ra for 2-ethylhexyl acetate and Ra for xylene, calculated by Equation 2, are each independently about 0 MPa^{1/2} to about 5 MPa^{1/2}.

3. The solvent of claim 2, wherein
Ra for 2-ethylhexyl acetate as calculated by Equation 2 is about 0 MPa^{1/2} to about 3 MPa^{1/2}, or
Ra for xylene as calculated by Equation 2 is about 0 MPa^{1/2} to about 5 MPa^{1/2}.

4. The solvent of claim 1, wherein the solvent has a boiling point of about 145° C. to about 220° C.

5. The solvent of claim 1, wherein the solvent has a flash point of about 30° C. to about 90° C.

6. The solvent of claim 1, wherein the solvent comprises isobutyl isobutyrate, n-butyl butyrate, 2-ethylhexyl acetate, ethyl hexanoate, diisobutyl ketone, n-heptyl acetate, hexyl acetate, d-limonene, trimethylbenzene, isopropylbenzene, or a combination thereof.

7. A binder composition, comprising:
a solvent according to claim 1; and
a binder.

8. The binder composition of claim 7, wherein the binder comprises a butadiene rubber, a butyl rubber, an acrylic rubber, an acrylate resin, a silicon resin, a fluorine-containing elastomer, a urethane-containing elastomer, or a combination thereof.

9. The binder composition of claim 7, wherein the binder comprises a polybutadiene rubber, a nitrile-butadiene rubber, a hydrogenated nitrile-butadiene rubber, a styrene-butadiene rubber, a styrene-butadiene-styrene rubber, a acrylate-butadiene rubber, a methacrylate-butadiene rubber, an acrylonitrile-butadiene-styrene rubber, a polyacrylate rubber, polyisobutene, a polyolefin elastomer, ethylene-propylene-diene terpolymer rubber, isobutylene-isoprene rubber, poly(ethylene-co-vinyl acetate), a chloroprene rubber, a chlorosulfonated polyethylene, polyvinylidene fluoride-co-hexafluoropropylene, a polyurethane, or a combination thereof.

10. The binder composition of claim 7, wherein the binder composition has a solids content of about 0.1 wt % to about 20 wt %, based on total weight of the binder composition.

11. A solid electrolyte layer,
wherein the solid electrolyte layer is formed from a solid electrolyte slurry, and
wherein the solid electrolyte slurry comprises:
a sulfide-containing solid electrolyte;
a solvent according to claim 1; and
a binder.

12. The solid electrolyte layer of claim 11, wherein the sulfide-containing solid electrolyte comprises Li₂S—P₂S₅; Li₂S—P₂S₅—LiX wherein X is a halogen; Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCL; Li₂S—SiS₂—B₂S₃—LiI; Li₂S—SiS₂—P₂S₅—LiI; Li₂S—B₂S₃; Li₂S—P₂S₅—ZₘSₙ wherein m and n are each a positive number, and Z is Ge, Zn, Ga, or a combination thereof; Li₂S—GeS₂; Li₂S—SiS₂—Li₃PO₄; or Li₂S—SiS₂-LiₚMO_{q} wherein p and q are each a positive number, and M is P, Si, Ge, B, Al, Ga, or In; or a combination thereof.

13. The solid electrolyte layer of claim 11, wherein the sulfide-containing solid electrolyte comprises a solid electrolyte represented by Formula 1:
Li⁺_{12-n-z}Aⁿ⁺B²⁻_{6-z}Y′⁻_{z} Formula 1
wherein, in Formula 1,
A is P, As, Ge, Ga, Sb, Si, Sn, Al, In, TI, V, Nb, or Ta,
B is S, Se, or Te,
Y′ is Cl, Br, I, F, CN, OCN, SCN, or N₃,
1<n<5, and
0<z<2.

14. The solid electrolyte layer of claim 11, wherein the solid electrolyte slurry has a solids content of about 50 wt % to about 70 wt %, based on total weight of the solid electrolyte slurry.

15. The solid electrolyte layer of claim 11, wherein the sulfide-containing solid electrolyte is present in an amount of about 90 parts by weight to about 99.9 parts by weight, based on 100 parts by weight of the solid electrolyte layer.

16. The solid electrolyte layer of claim 11, wherein the binder is present in an amount of about 0.1 parts by weight to about 10 parts by weight, based on 100 parts by weight of the solid electrolyte layer.

17. The solid electrolyte layer of claim 11, wherein the solid electrolyte slurry further comprises a dispersing agent, a leveling agent, a defoaming agent, or a combination thereof.

18. The solid electrolyte layer of claim 11, wherein the solid electrolyte layer has a thickness of about 10 micrometers to about 150 micrometers.

19. The solid electrolyte layer of claim 11, wherein the solid electrolyte layer has an ionic conductivity of about 0.1 millisiemens per centimeter to about 5 millisiemens per centimeter when measured at 25° C.

20. An electrode comprising:
an electrode current collector; and
an electrode active material layer disposed on the electrode current collector,
wherein the electrode active material layer is formed using an electrode active material slurry comprising an electrode active material, a sulfide-containing solid electrolyte, a solvent according to claim 1, a conductive material, and a binder.
